(19) United States
(12) Patent Application Publication
(10) Pub. No.: US 2026/0205004 A1
(43) Pub. Date: Jul. 16, 2026

(54) SWITCHED-CAPACITOR CONVERTER WITH ZERO-VOLTAGE AND ZERO-CURRENT SWITCHING CONTROL AND CONTROL METHOD THEREOF

(71) Applicant: Richtek Technology Corporation, Hsinchu (TW)

(72) Inventors: Ye-Sing LUO, Hsinchu (TW); Shui-Mu LIN, Hsinchu (TW); Jiun-Jang LIN, Hsinchu (TW); Kuo-Chi LIU, Hsinchu (TW)

(21) Appl. No.: 19/290,377

(22) Filed: Aug. 5, 2025

Related U.S. Application Data
(60) Provisional application No. 63/745,811, filed on Jan. 16, 2025.

(30) Foreign Application Priority Data
Apr. 25, 2025 (TW) 114115796

(51) Int. Cl. H02M 1/08; H02M 3/07

(52) U.S. Cl. CPC H02M 1/083; H02M 3/07

(57) ABSTRACT

The present invention relates to a switched-capacitor converter comprising N flying capacitors (where N ≥ 1) and a plurality of switches configured to perform periodic switching between a plurality of switching phases to convert a first voltage into a second voltage, or vice versa. Upon entering one of the switching phases, referred to as the first switching phase, the first terminal of at least one of the N flying capacitors is switched earlier than its second terminal to electrically connect to a corresponding node in the first switching phase, thereby forming a required coupling relation for the phase. This configuration allows the second terminal to gradually approach a zero-voltage switching (ZVS) before being subsequently switched, which enables the corresponding switch to operate under ZVS condition. As a result, switching loss is reduced and power conversion efficiency is improved.

### CROSS REFERENCE

The present invention claims priority to US 63/745811 filed on January 16, 2025, and claims priority to TW 114115796 filed on April 25, 2025.

### BACKGROUND OF THE INVENTION

### Field of Invention

The present invention relates to switched-mode power conversion technologies, and more particularly, to a switched-capacitor converter with zero-voltage switching (ZVS) and zero-current switching (ZCS) control, and a control method thereof.

### Description of Related Art

The development trend of modern electronic devices imposes increasingly stringent requirements on power converters, especially in mobile devices, embedded systems, and other high-performance applications, where demands on converter size, efficiency, and thermal management continue to rise. Due to growing constraints in space and temperature, conventional switched-capacitor converter designs encounter challenges under high power density conditions. In particular, when traditional converters perform phase switching, voltage mismatches across flying capacitors can result in instantaneous large current, causing significant switching losses and impairing overall efficiency.

In the prior art, conventional 4:1 step-down Dickson switched-capacitor converters (as illustrated in FIG. 1A) typically adopt a hard-charging method for energy transfer, with switching control signals as shown in FIG. 1B. In such designs, the flying capacitor network is directly connected to the output end and utilizes the output capacitor Co as a voltage source load. However, during phase switching, mismatches between the voltages of flying capacitors and the output node induce rapid charge redistribution, which generates instantaneous large currents. These currents result in high switching power losses, reduce conversion efficiency, and increase system heat. Furthermore, such large transient currents also cause voltage spikes, thereby increasing the required voltage rating of switches and associated costs.

In view of the foregoing, the present invention aims to overcome the deficiencies of prior art and provides a switched-capacitor converter capable of reducing surge currents.

### SUMMARY OF THE INVENTION

From one perspective, the present invention provides a switched-capacitor converter comprising: N flying capacitors, where N is equal to or greater than 1; a plurality of switches configured to perform periodic switching between a plurality of switching phases to convert a first voltage into a second voltage or to convert the second voltage into the first voltage; wherein upon entering a first switching phase between the plurality of switching phases, a first terminal of one flying capacitor of the N flying capacitors is switched earlier than a second terminal thereof to electrically connect to a node corresponding to the first switching phase, thereby forming a required coupling relation for the first switching phase, such that the second terminal gradually approaches a zero-voltage state before being subsequently switched to electrically connect to a corresponding node in the first switching phase, thereby achieving zero-voltage switching.

In one preferred embodiment, under steady-state operation, a voltage of the first terminal is lower than a voltage of the second terminal.

In one preferred embodiment, a terminal-phase voltage difference (ΔV_T) of the second terminal is greater than or equal to a terminal-phase voltage difference of the first terminal, wherein each terminal-phase voltage difference refers to an absolute value of a voltage level difference at the corresponding terminal across the plurality of switching phases.

In one preferred embodiment, each cross terminal-phase voltage difference includes a decrease or increase in -voltage, due to load variation, of at least part of the N flying capacitors.

In one preferred embodiment, when N is greater than 1, in the first switching phase in which the N flying capacitors are electrically connected in series to form a voltage distribution, a selected flying capacitor having a largest terminal-phase voltage differences among the N flying capacitors is controlled such that a first terminal thereof is switched first, and subsequently a second terminal thereof is switched, so as to ensure that the second terminal of the selected flying capacitor gradually approaches a zero-voltage state, thereby achieving zero-voltage switching.

In one preferred embodiment, in the first switching phase, the other flying capacitors of the N flying capacitors are sequentially switched at the respective first terminals according to the voltage distribution, such that the second terminal of the selected flying capacitor gradually approaches a zero-voltage state, thereby enabling zero-voltage switching when the second terminal of the selected flying capacitor is switched to electrically connected to the corresponding node in the first switching phase.

In one preferred embodiment, in the first switching phase, the second terminal of the selected flying capacitor is a last terminal, among the N flying capacitors electrically connected in series, to be switched and electrically connected to the corresponding node in the first switching phase.

In one preferred embodiment, in the first switching phase, the N flying capacitors are switched sequentially such that the voltages of the first and second terminals of each of the N flying capacitors increases gradually.

In one preferred embodiment, when two or more flying capacitors of the N flying capacitors exhibit the largest terminal-phase voltage difference in the first switching phase, one among the two or more flying capacitors having a highest voltage potential at the corresponding first terminal is determined as the selected flying capacitor.

In one preferred embodiment, the N flying capacitors are electrically connected in series to exhibit a voltage distribution in the first switching phase, and, upon switching to a second switching phase, the N flying capacitors are switched from series electrical connection to non-series electrical connection, wherein the corresponding first terminal of one of the N flying capacitors at a low-voltage end of the voltage distribution is first switched to electrically connect to a corresponding node in the second switching phase, and the respective first terminals of others of the N flying capacitors are switched sequentially according to the voltage distribution, thereby ensuring sequential disconnection of the series electrical connection and achieving zero-voltage switching at least partially.

In one preferred embodiment, in the second switching phase, the N flying capacitors are switched from a series electrical connection to a parallel electrical connection.

In one preferred embodiment, in the second switching phase, voltages of the first terminal and the second terminal of each of the N flying capacitors decreases gradually by sequential switching.

In one preferred embodiment, a switching sequence of the N flying capacitors in the second switching phase is opposite to a switching sequence forming a series electrical connection in the first switching phase.

In one preferred embodiment, the plurality of switches include: a first switch, coupled between the first voltage and a second terminal of the one flying capacitor; a second switch, coupled between a first terminal of the one flying capacitor and the second voltage; a third switch, coupled between the second terminal of the one flying capacitor and the second voltage; and a fourth switch, coupled between the first terminal of the one flying capacitor and a ground potential.

In one preferred embodiment, in the first switching phase, the second switch is turned on earlier than the first switch, such that the first switch is turned on under zero-voltage switching to charge the one flying capacitor; and in a second switching phase, the fourth switch is turned on earlier than the third switch, such that the third switch is turned on under zero-voltage switching to discharge the one flying capacitor.

In one preferred embodiment, a conversion ratio between the first voltage and the second voltage is 2:1.

In one preferred embodiment, the first switch is turned on after a predetermined delay time following the turn-on of the second switch, and/or, the third switch is turned on after a predetermined delay time following the turn-on of the fourth switch.

In one preferred embodiment, the first switch is turned on when a cross-voltage of the first switch is lower than a threshold value to achieve zero-voltage switching, and/or, the third switch is turned on when a cross-voltage of the third switch is lower than a threshold value to achieve zero-voltage switching.

In one preferred embodiment, the switched-capacitor converter has a conversion ratio between the first voltage and the second voltage being K:1 and corresponds to a series-parallel switched-capacitor converter, where K is an integer greater than 2.

In one preferred embodiment, the switched-capacitor converter has a conversion ratio between the first voltage and the second voltage being K:1 and corresponds to a pipeline switched-capacitor converter or a Dickson switched-capacitor converter, where K is an integer greater than 2.

From another perspective, the present invention provides a method for switched-capacitor power conversion, comprising: performing periodic switching between a plurality of switching phases to convert power between a first voltage and a second voltage; wherein upon entering a first switching phase, controlling a first terminal of one flying capacitor of N flying capacitors to be electrically connected to a corresponding node earlier, such that a second terminal thereof gradually approaches a zero-voltage state before being switched, thereby achieving zero-voltage switching, wherein N is greater than or equal to 1.

The present invention provides a novel control method for switched-capacitor converters by implementing zero-voltage switching and zero-current switching techniques. Through appropriate timing control, the invention enables gradual voltage transitions on critical switching elements, allowing them to turn on under ZVS or ZCS conditions, thereby effectively reducing switching losses. Moreover, the proposed control method can be applied to various converter architectures, including Dickson structures, pipeline structures, and series-parallel hybrid structures, to further improve overall conversion efficiency, enhance thermal management, and meet the requirements of high power density applications.

The objectives, technical details, features, and effects of the present invention will be better understood with regard to the detailed description of the embodiments below, with reference to the attached drawings.

### BRIEF DESCRIPTION OF THE DRAWINGS

FIG. 1A illustrates a circuit diagram of a switched-capacitor converter in accordance with the prior art.

FIG. 1B illustrates a timing diagram of switch control signals corresponding to the converter shown in FIG. 1A.

FIG. 2A illustrates a schematic diagram of a switched-capacitor converter with single flying capacitor according to one embodiment of the present invention.

FIG. 2B illustrates a switch state diagram during the charging phase of the switched-capacitor converter corresponding to FIG. 2A.

FIG. 2C illustrates a switch state diagram during the discharging phase of the switched-capacitor converter corresponding to FIG. 2A.

FIG. 3 illustrates control signals and cross-voltage waveforms of the switched-capacitor converter corresponding to FIG. 2A.

FIG. 4 illustrates a schematic diagram of a zero-voltage detection circuit according to one embodiment of the present invention.

FIG. 5A illustrates a schematic diagram of a switched-capacitor converter with three flying capacitors according to another embodiment of the present invention.

FIG. 5B illustrates a switch state diagram during the charging phase of the switched-capacitor converter corresponding to FIG. 5A.

FIG. 5C illustrates a switch state diagram during the discharging phase of the switched-capacitor converter corresponding to FIG. 5A.

FIG. 6 illustrates control signals and cross-voltage waveforms of the switched-capacitor converter corresponding to FIG. 5A within a complete switching cycle.

FIG. 7A illustrates a schematic diagram of a two-phase interleaved pipeline switched-capacitor converter according to one embodiment of the present invention.

FIG. 7B illustrates a switch state diagram during the first switching phase of the switched-capacitor converter corresponding to FIG. 7A.

FIG. 7C illustrates a switch state diagram during the second switching phase of the switched-capacitor converter corresponding to FIG. 7A.

FIG. 8 illustrates control signals and cross-voltage waveforms of the two-phase interleaved switched-capacitor converter corresponding to FIG. 7A.

FIG. 9A illustrates a schematic diagram of a three flying capacitor 4:1 Dickson switched-capacitor converter according to one embodiment of the present invention.

FIG. 9B illustrates an electrical connection state diagram during the first switching phase of the switched-capacitor converter corresponding to FIG. 9A.

FIG. 9C illustrates an electrical connection state diagram during the second switching phase of the switched-capacitor converter corresponding to FIG. 9A.

FIG. 10 illustrates control signals and cross-voltage waveforms of the switched-capacitor converter corresponding to FIG. 9A within a complete switching cycle.

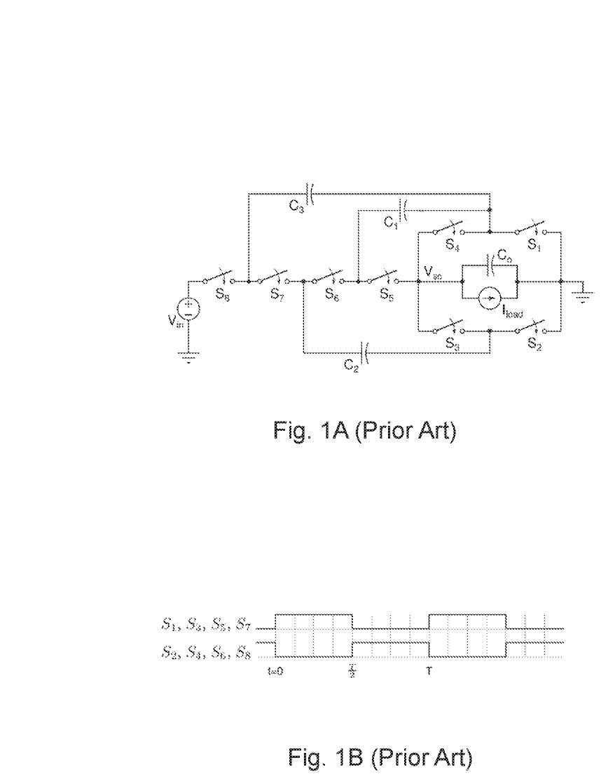

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

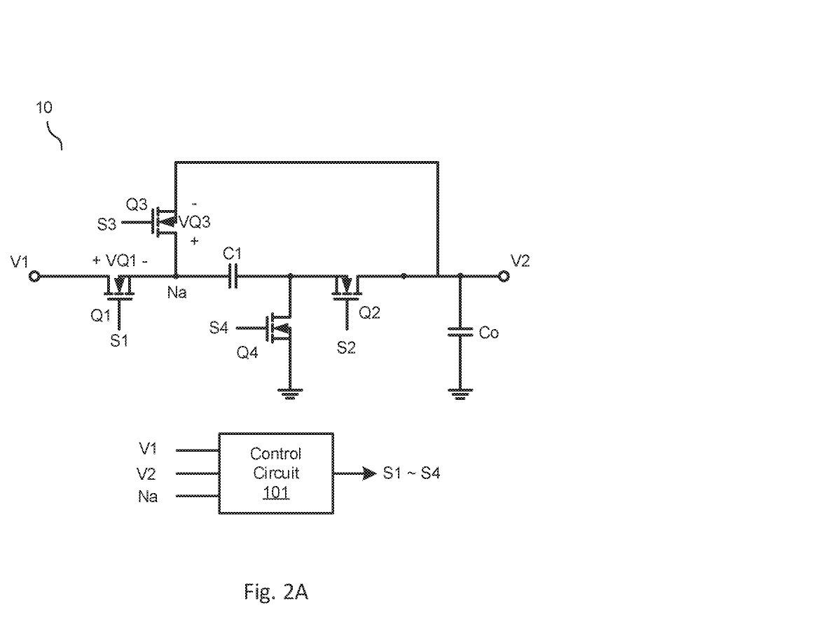

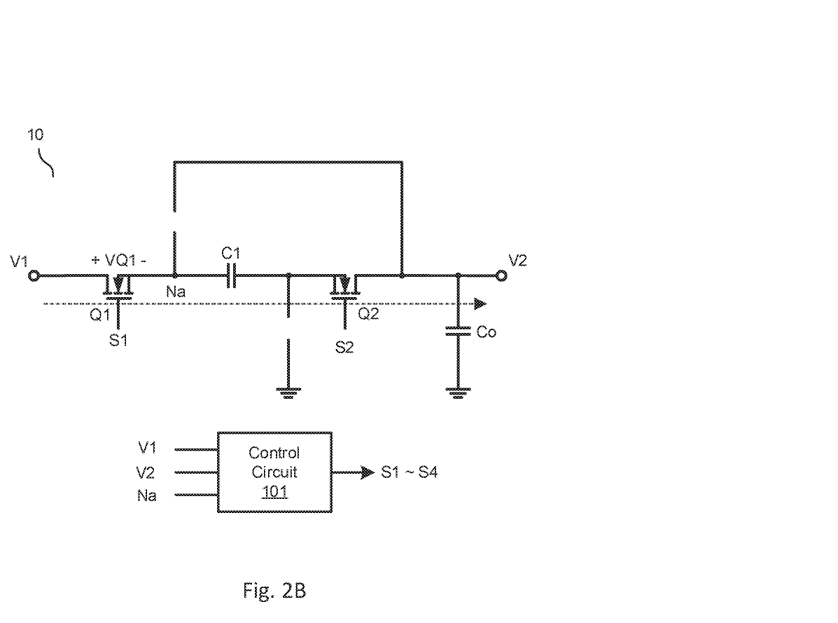

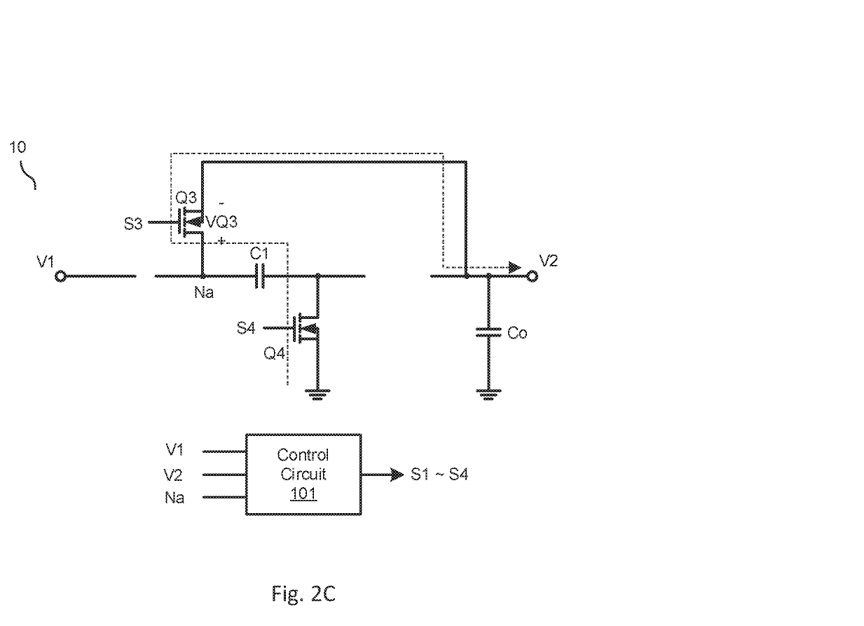

FIG. 2A illustrates a circuit schematic of a switched-capacitor converter according to a preferred embodiment of the present invention. As shown, the converter comprises a flying capacitor C1 and at least four switches Q1 to Q4, sequentially connected in series between a first voltage and a ground potential. Specifically, a first switch Q1 is coupled between the first voltage and a second terminal of the flying capacitor C1; a second switch Q2 is coupled between a first terminal of the flying capacitor C1 and a second voltage; a third switch Q3 is coupled between the second terminal of the flying capacitor C1 and the second voltage; and a fourth switch Q4 is coupled between the first terminal of the flying capacitor C1 and the ground potential. It should be noted that the first terminal of the flying capacitor C1 refers to the right terminal in FIG. 2A, while the second terminal refers to the left terminal (at node Na). A control circuit 101 is configured to generate switching control signals S1 to S4 to control the turn-on and turn-off of the above switches, so as to perform periodic switching between different switching phases. By optimizing the switching sequence, selected switches (e.g., Q1 and Q3) can be turned on under zero-voltage switching (ZVS) conditions to reduce switching loss and improve conversion efficiency. Additionally, the flying capacitor C1 and an output capacitor Co can be coupled to form a voltage divider structure, which helps stabilize the second voltage output and supports energy transfer from the first voltage to the second voltage. Bidirectional power transfer is also feasible during reverse operation.

As shown in FIG. 2A, in this embodiment, the flying capacitor C1 and the output capacitor Co together form a voltage divider structure that converts the first voltage V1 into a stable second voltage V2. In the first switching phase, the control circuit 101 first turns on Q2 and subsequently turns on Q1, such that Q1 is turned on under a ZVS condition. In the second switching phase, Q4 is first turned on, followed by turning on Q3, to ensure that Q3 is also turned on under a ZVS condition.

In one embodiment, the switched-capacitor converter comprises N flying capacitors (C1 to CN, where N ≥ 1) and a plurality of switches (Q1 to Qx, where x ≥ 4), configured to perform periodic switching between a plurality of switching phases to convert a first voltage V1 into a second voltage V2, or to convert the second voltage V2 into the first voltage V1. In this case, upon entering a switching phase (e.g., the first switching phase), a first terminal of one flying capacitor can be switched, before the second terminal, to electrically connect to a corresponding node in the switching phase (e.g., the first switching phase), and the second terminal is subsequently switched when the voltage difference gradually decreases. This sequential switching allows switching losses to be reduced and conversion efficiency to be improved.

In one embodiment, under steady-state operation, the voltage of the first terminal of one flying capacitor is lower than the voltage of the second terminal. Upon entering a switching phase (e.g., the first switching phase), when the first terminal of the flying capacitor is switched earlier than the second terminal and electrically connected to the corresponding node in the first switching phase, a coupling relation required for the switching phase can be formed. This enables the second terminal, while still not switched yet, to gradually approach a zero-voltage state, thereby facilitating its subsequent being switched under a low cross-voltage condition. Such a switching sequence helps reduce switching loss and enhance conversion efficiency, and can be further optimized in conjunction with multi-capacitor embodiments described below.

FIG. 2B further illustrates the switching state during the charging phase. As shown in FIG. 2B, during the charging phase, switches Q1 and Q2 are turned on, while switches Q3 and Q4 remain off, forming a series electrical connection among flying capacitor C1, the first voltage V1, and the second voltage V2. This configuration enables the flying capacitor C1 to be charged from the first voltage V1 to the second voltage V2, thereby completing the energy transfer. According to the present invention, the charging phase may include the following sub-phases for switching control.

Charging Sub-Phase 1: The switch control signal S2 is first asserted to an enabling level, causing the switch Q2 to turn on and electrically connect the first terminal (right terminal) of the flying capacitor C1 to the second voltage V2.

Charging Sub-Phase 2: The switch control signal S1 is subsequently asserted to an enabling level, causing the switch Q1 to turn on and electrically connect the second terminal (left terminal) of the flying capacitor C1 to the first voltage V1. This completes the electrical connection state of the charging phase and enables switch Q1 to achieve ZVS.

FIG. 2C illustrates the switching state during the discharging phase. As shown in FIG. 2C, during the discharging phase, the switches Q3 and Q4 are turned on, while the switches Q1 and Q2 remain off. The flying capacitor C1 is now electrically connected in parallel with the second voltage V2 and the ground potential, enabling energy to be discharged from the flying capacitor C1 to the second voltage V2. The charging phase may include the following sub-phases for switching control.

Discharging Sub-Phase 1: The switch control signal S4 is first asserted to an enabling level, causing the switch Q4 to turn on and electrically connect the right terminal of the flying capacitor C1 to the ground potential.

Discharging Sub-Phase 2: The switch control signal S3 is subsequently asserted to an enabling level, causing the switch Q3 to turn on and electrically connect the left terminal of the flying capacitor C1 to the second voltage V2. This completes the electrical connection state of the discharging phase and allows the switch Q3 to achieve ZVS.

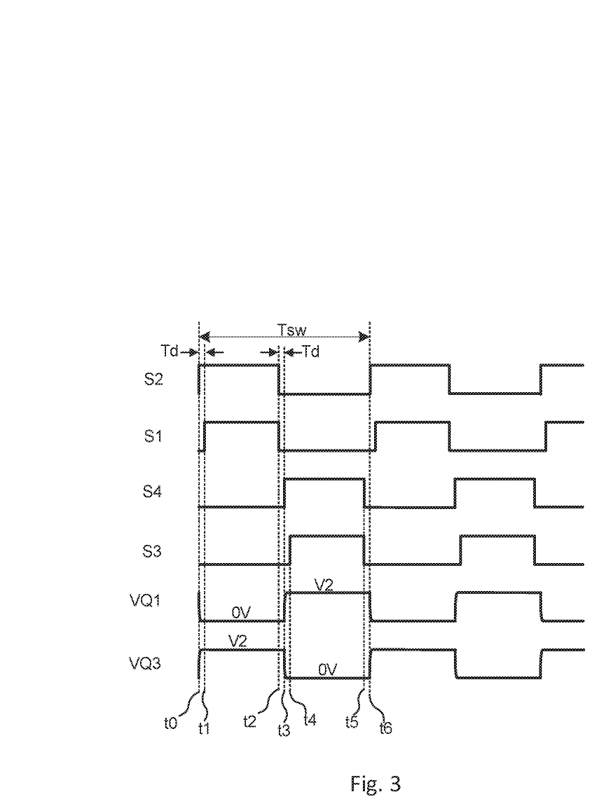

FIG. 3 illustrates signal waveforms of relevant control signals for a switched-capacitor converter according to one embodiment of the present invention. As shown in FIG. 3, a complete switching cycle Tsw (from time t0 to t6) includes a charging phase and a discharging phase. The control sequence is as follows.

Charging phase (time t0 to t2): At time t0, the switch control signal S2 is driven high, turning on the switch Q2. The cross-voltage VQ1 of the switch Q1 begins to decrease. At time t1, once the cross-voltage VQ1 drops to 0 (i.e., zero-voltage state), the switch Q1 can be turned on under a zero-voltage switching (ZVS) condition to perform charging of the flying capacitor C1. The intervals t0–t1 and t1–t2 correspond to the first and second charging sub-phases, respectively. At time t2, the switch control signals S1 and S2 are driven low, turning off the switches Q1 and Q2. A dead time (t2–t3) is inserted, during which the switches Q1 to Q4 are all turned off to avoid short circuits.

Discharging phase (time t3 to t5): At time t3, the switch control signal S4 is driven high, turning on the switch Q4. The cross-voltage VQ3 of the switch Q3 begins to decrease. At time t4, once VQ3 drops to 0, the switch Q3 can be turned on under a ZVS condition to perform discharging of the flying capacitor C1. The intervals t3–t4 and t4–t5 correspond to the first and second discharging sub-phases, respectively. At time t5, the switch control signals S3 and S4 are driven low, turning off the switches Q3 and Q4, entering another dead time in preparation for the next switching cycle.

Accordingly, in this switching sequence, the switches Q1 and Q3 are turned on under ZVS conditions, while the switches Q2 and Q4 are turned on under zero-current switching (ZCS) conditions. This ensures maximum conversion efficiency while reducing switching loss and device stress.

In one embodiment, during the charging phase, after the first-terminal switch (such as Q2 or Q4, coupled to the first terminal of the flying capacitor C1) is turned on, a predetermined delay time (denoted Td in FIG. 3) is introduced to determine the timing for turning on the second-terminal switch (such as Q1 or Q3, coupled to the second terminal of the flying capacitor C2). This ensures that the second-terminal switch is turned on after its cross-voltage has sufficiently dropped, thereby achieving ZVS. The predetermined delay time can be configured based on device characteristics and circuit design, so that even without real-time voltage detection, the selected switch can still operate under ZVS, effectively reducing switching loss.

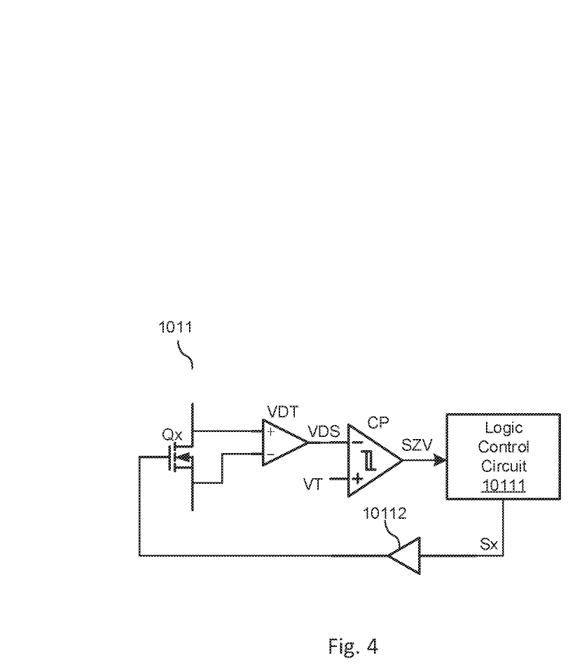

Please refer to FIG. 4, which illustrates a zero-voltage detection circuit according to one embodiment of the present invention. In another embodiment, the aforementioned delay time can be adaptive. As shown in FIG. 4, a zero-voltage detection circuit 1011 is configured to detect the cross-voltage of the switch Qx (e.g., Q1 or Q3) after the first-terminal switch (such as Q2 or Q4) is turned on. When the cross-voltage of the switch Qx drops below a predetermined threshold voltage VT, the detection circuit triggers a switching control signal to enable ZVS.

In this embodiment, a voltage detector VDT is configured to sense the cross-voltage of the switch Qx to generate a voltage signal VDS. This voltage signal VDS is fed to a comparator CP. The comparator CP compares VDS with the predetermined threshold VT to generate a zero-voltage signal SZV. When the voltage signal VDS is lower than the predetermined threshold VT, a logic control circuit 10111 generates a switch control signal Sx, which then drives the switch Qx to turn on via a driver 10112.

For example, in the converter shown in FIG. 2A, the cross-voltage VQ1 of the switch Q1 is the voltage between the first voltage V1 and the switching node Na. When the switch Q2 is turned on, VQ1 gradually decreases. Once it drops below the predetermined threshold, the logic control circuit 10111 generates a switch control signal Sx to turn on the switch Q1 under a ZVS condition. The same mechanism can also be applied to the switch Q3 to achieve ZVS.

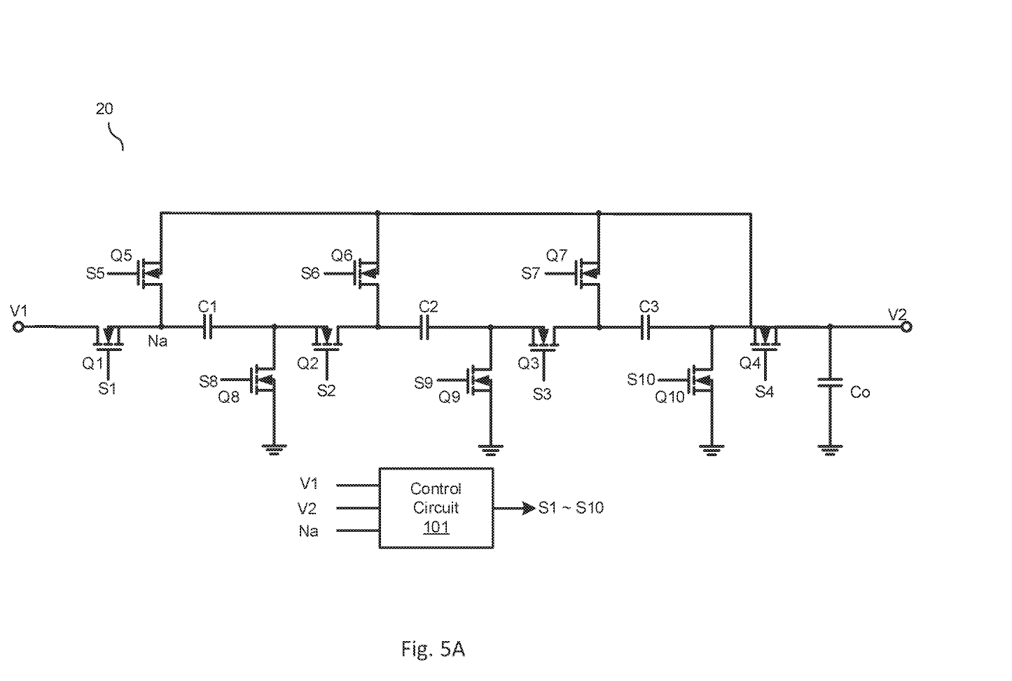

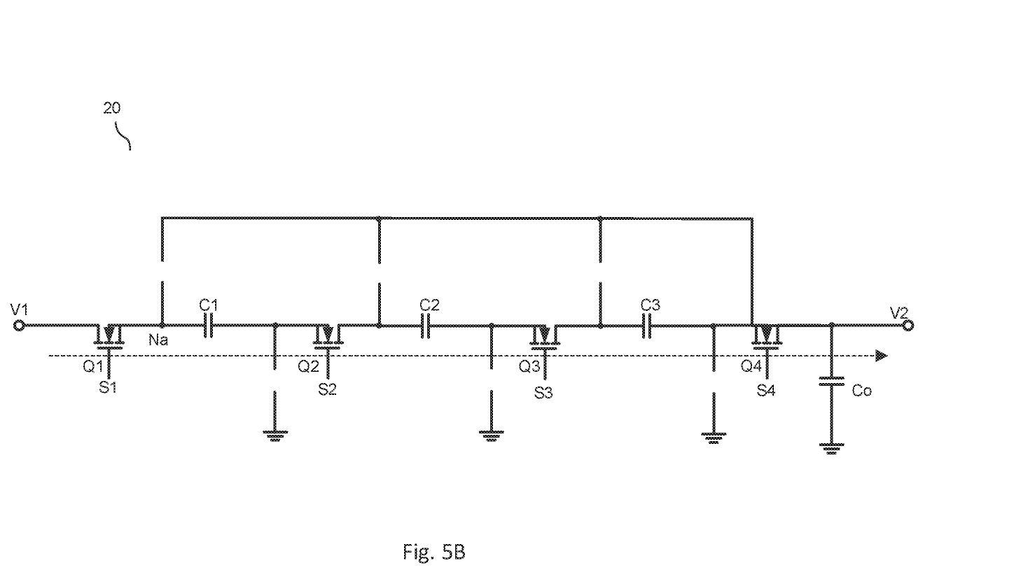

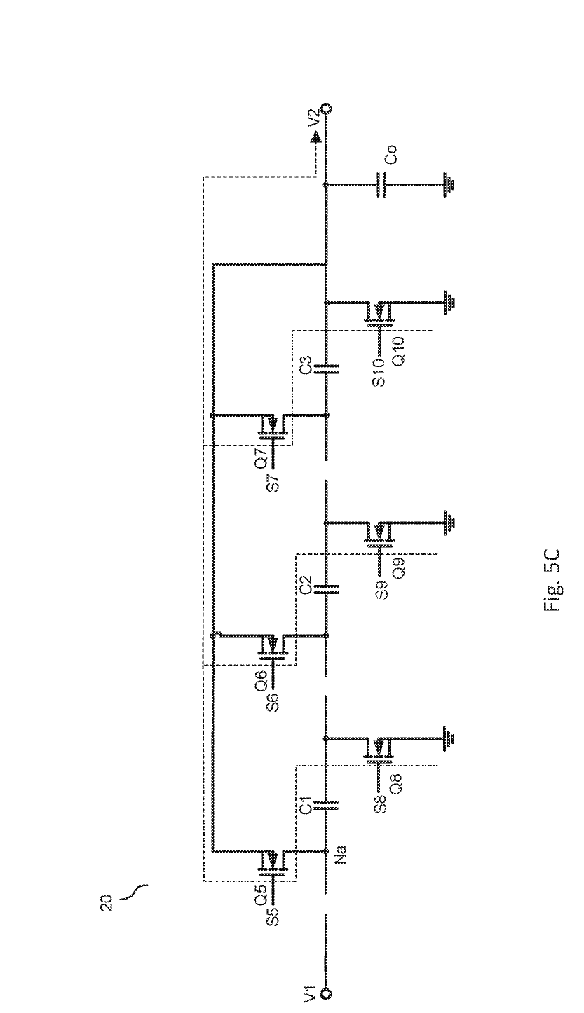

FIG. 5A illustrates a circuit schematic of a switched-capacitor converter according to another preferred embodiment of the present invention. As shown in FIG. 5A, the switched-capacitor converter 20 includes switches Q1 to Q10, an output capacitor Co, the flying capacitors C1 to C3, and a control circuit 101. The flying capacitors C1 to C3 are coupled with the switches Q1 to Q10 to form a voltage divider. Output capacitor Co is configured to store the second voltage V2. The control circuit 101 generates switch control signals S1 to S10 and sequentially controls the switches Q1 to Q10 to achieve ZVS and/or ZCS, thereby enhancing conversion efficiency. Moreover, this embodiment supports bidirectional power transfer, allowing power transfer from the first voltage V1 to the second voltage V2 or from the second voltage V2 to the first voltage V1.

In this embodiment, the flying capacitors C1 to C3 are switched through a plurality of switches during the charging and discharging phases to form a series or parallel electrical connection for energy transfer. Specifically, during the charging phase, as illustrated in FIG. 5B, the flying capacitors C1 to C3 are electrically connected sequentially to form a series electrical connection. In the first charging sub-phase, the switch Q2 is turned on to electrically connect the right terminal of C1 to the left terminal of C2. In the second charging sub-phase, the switch Q3 is turned on to electrically connect the right terminal of C2 to the left terminal of C3. In the third charging sub-phase, the switch Q4 is turned on to electrically connect the right terminal of C3 to the second voltage V2. Finally, in the fourth charging sub-phase, the switch Q1 is turned on to electrically connect the left terminal of C1 to the first voltage V1, thereby completing the charging of the flying capacitors. This turn-on sequence enables progressive voltage stacking with gradual voltage variation, facilitating ZVS or ZCS and reducing switching loss and surge current.

Conversely, during the discharging phase, the flying capacitors C1 to C3 are reconfigured into a parallel or partial-parallel electrical connection to output to the second voltage V2. As shown in FIG. 5C, the discharging process is also divided into four sub-phases to gradually deconstruct the series electrical connection established during charging. In the first discharging sub-phase, the switch Q10 is turned on to electrically connect the right terminal of the flying capacitor C3 to ground potential. In the second discharging sub-phase, the switches Q7 and Q9 are turned on to electrically connect the left terminal of C3 to the second voltage V2 and the right terminal of C2 to ground potential. In the third discharging sub-phase, the switches Q6 and Q8 are turned on to electrically connect the left terminal of C2 to the second voltage V2 and the right terminal of C1 to ground potential. In the fourth discharging sub-phase, the switch Q5 is turned on to electrically connect the left terminal of C1 to the second voltage V2, completing the discharging phase. This sequential activation facilitates the progressive reduction of switch cross-voltages, allowing the switches Q5, Q6, and Q7 to achieve zero-voltage switching and suppress inrush current.

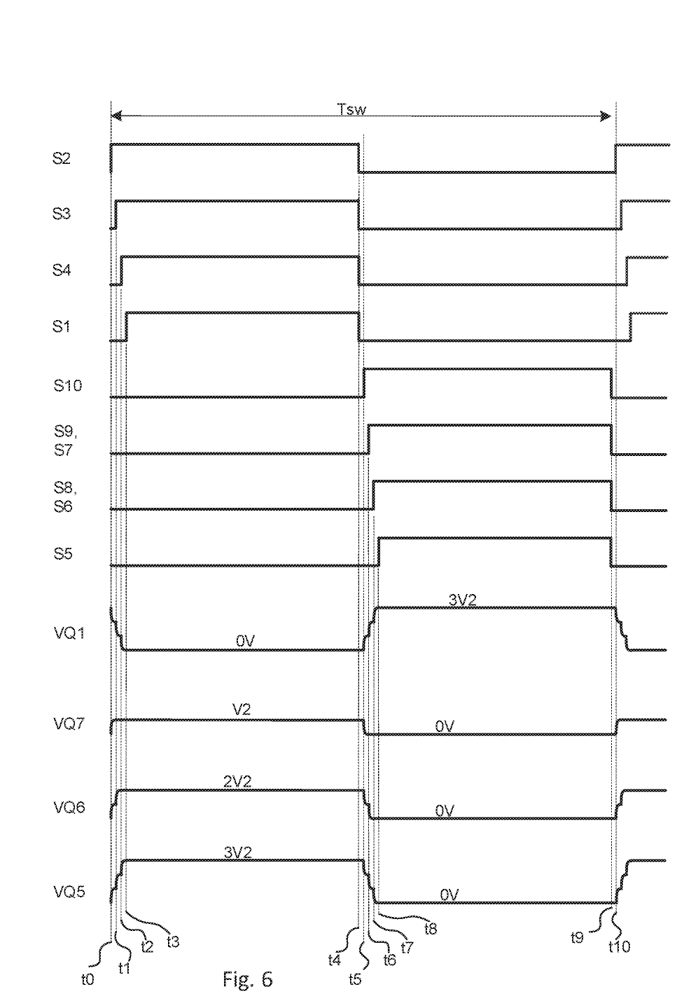

FIG. 6 illustrates the signal waveform of the switched-capacitor converter according to one embodiment of the present invention. It covers a complete switching cycle Tsw (from time t0 to t10), including the charging and discharging phases of the flying capacitors C1 to C3. In this embodiment, each flying capacitor operates under a steady-state DC bias voltage (Vc1 = Vc2 = Vc3 = V2), and V1 = 4×V2. During the charging phase: From t0 to t1 (first charging sub-phase), the switch Q2 is turned on, causing the cross-voltage VQ1 of the switch Q1 to drop from 3×V2 to 2×V2, corresponding to the voltage difference (V1 – Vc1 – Vc2 = 2×V2). From t1 to t2 (second charging sub-phase), Q3 is turned on, reducing VQ1 from 2×V2 to V2, i.e., VQ1 = V1 – Vc1 – Vc2 – Vc3 = V2. From t2 to t3 (third charging sub-phase), Q4 is turned on, further reducing VQ1 to zero (i.e., VQ1 = V1 – Vc1 – Vc2 – Vc3 – Vc4 = 0), ensuring that Q1 can be turned on at t3 under ZVS conditions. During t3 to t4 (fourth charging sub-phase), the flying capacitors C1 to C3 are electrically connected in series between the first voltage V1 and the second voltage V2 to proceed charging.

During the dead time (t4 to t5), all the switches Q1 to Q10 remain off to prevent short circuits.

Next, during the discharging phase: From t5 to t6 (first discharging sub-phase), the switch Q10 is turned on, reducing the cross-voltages of Q5, Q6, and Q7 each by V2, with VQ7 dropping from V2 to zero. From t6 to t7 (second discharging sub-phase), Q7 is turned on to achieve ZVS, and Q9 is turned on to further reduce VQ5 and VQ6 by V2 again, bringing VQ6 to zero. From t7 to t8 (third discharging sub-phase), Q6 is turned on under ZVS conditions, while Q8 reduces VQ5 from V2 to zero. At time t8, Q5 is turned on, also under ZVS. During t8 to t9 (fourth discharging sub-phase), the flying capacitors C1 to C3 are electrically connected in parallel between the second voltage V2 and ground to supply power to the second voltage V2.

In addition, the waveform diagram also shows the cross-voltage transitions of the switches Q1, Q7, Q6, and Q5. During the charging phase, as the terminal voltage of the flying capacitor C1 increase incrementally across each charging sub-phase, the cross-voltage of the switch Q1 decreases step-by-step, dropping approximately by V2 (i.e., one quarter of V1) per charging sub-phase, until it reaches zero, ensuring ZVS when Q1 is turned on. Similarly, during the discharging phase, the switches Q7, Q6, and Q5 also undergo progressive reductions in cross-voltage, corresponding to the decreasing terminal voltages of the flying capacitor C1, eventually achieving ZVS at their respective turn-on time points. Therefore, Q1, Q5, Q6, and Q7 all achieve ZVS when turning on, while the remaining switches operate with zero-current switching to suppress inrush current and reduce switching losses.

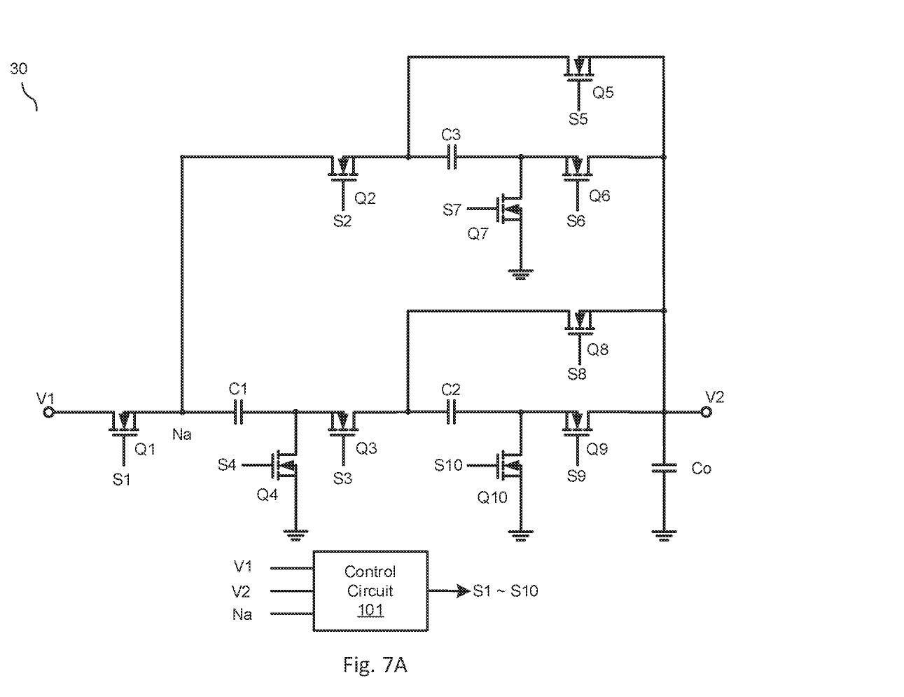

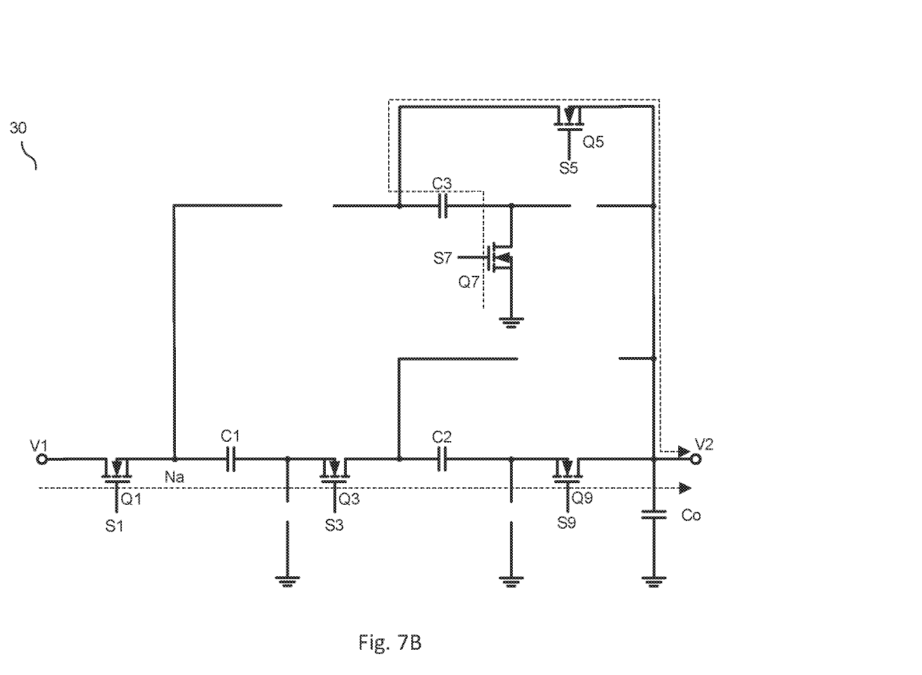

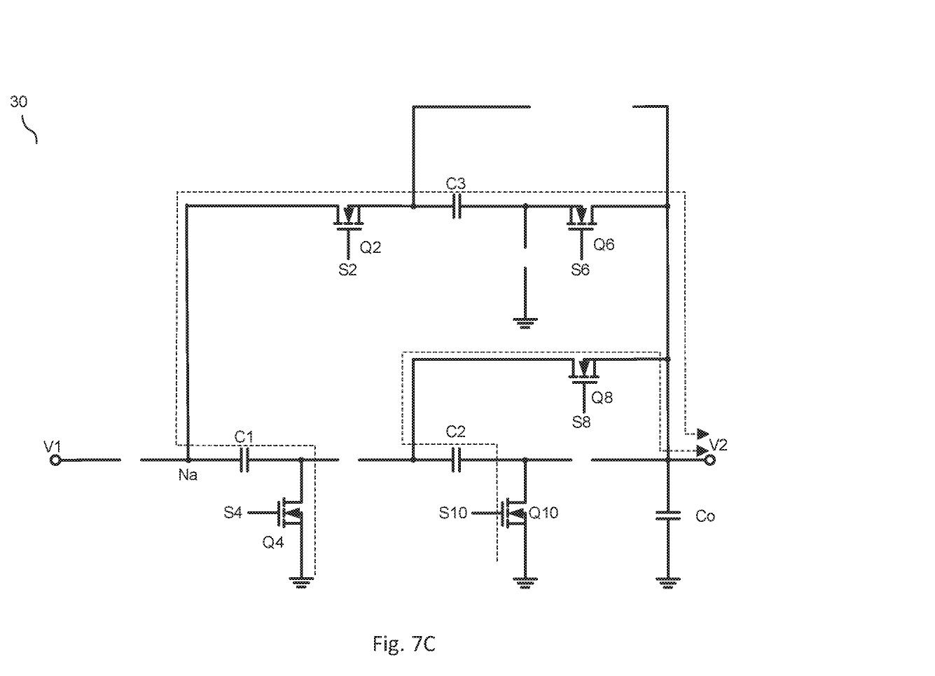

FIG. 7A illustrates an interleaved two-phase pipeline switched-capacitor converter according to another preferred embodiment of the present invention. As shown, the switched-capacitor converter 30 comprises three flying capacitors C1, C2, and C3 as the main energy transfer elements, and an interleaved switching network formed by switches Q1 to Q10 and a control circuit 101. The converter alternates between two switching phases for power conversion. In this configuration, the flying capacitor C1 functions as an intermediary bridge, with its left and right terminals connected respectively to two sub-converters.

The first sub-converter includes switches Q2, Q6, Q7, and Q5, operating with the flying capacitor C3. The second sub-converter includes switches Q3, Q9, Q10, and Q8, operating with the flying capacitor C2. These two sub-converters, together with the flying capacitor C1 and the switches Q1 and Q4, cooperatively perform power conversion between the first voltage V1 and the second voltage V2.

This embodiment features a topology having two-phase but non-parallel sub-converters. The flying capacitor C1, along with the switches Q1 and Q4, acts as a bridge between the two phases. The left and right terminals of C1 are alternately activated in different phases, enabling continuous pipeline-like energy transfer. This operation is further enhanced by applying ZVS or ZCS strategies to reduce switching losses and improve overall efficiency.

FIG. 7B illustrates the switching state during the first switching phase, in which operational logic structurally corresponds to the charging phase shown in FIG. 5B. In the first switching phase, the flying capacitors C1 and C2 are electrically connected in series through sequential activation of Q3 and Q9 during the first and second sub-phases. In the third sub-phase, the switch Q1 is turned on under ZVS, completing the series electrical connection of C1 and C2 between V1 and V2. Thus, in the first switching phase, C1 and C2 are charged and supplying power to V2. Additionally, in one embodiment, the flying capacitor C3 is electrically connected in parallel between the second voltage V2 and ground during the first switching phase through sequential turn-on of the switches Q7 and Q5 (either turn-on sequentially in the first and second sub-phases, or in the second and third sub-phases), thereby discharging C3 to V2. This division of switching roles can be regarded as an extension of the configuration in FIG. 5B, exhibiting characteristics of pipeline power conversion.

FIG. 7C illustrates the switching state in the second switching phase, which functionally corresponds to the discharging phase shown in FIG. 5C. In this second switching phase, the flying capacitor C2 is electrically connected in parallel with output capacitor Co through sequential activation of Q10 and Q8 to release stored energy to V2. At the same time, the flying capacitors C1 and C3 are electrically connected in series via Q4 and Q6, and finally discharged through Q2 to transfer their stored energy to the output. The overall timing sequence still follows the sequential sub-phase activation principle. Selected switches such as Q2 and Q8 are turned on after their cross-voltages have decreased, thereby achieving ZVS.

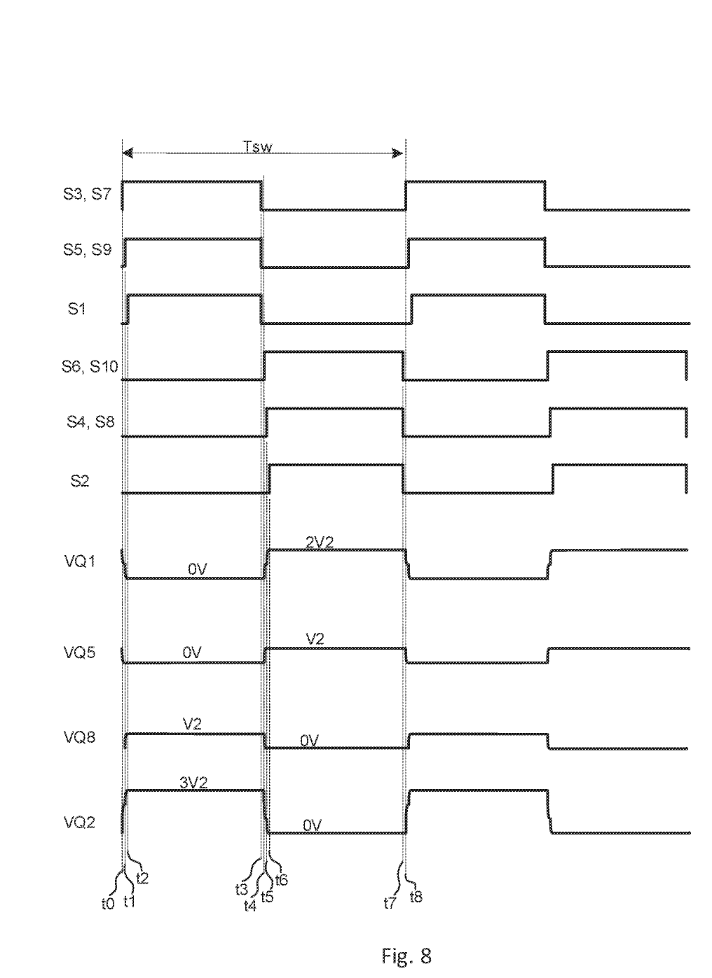

FIG. 8 illustrates waveform signals for a preferred embodiment of an interleaved two-phase pipeline switched-capacitor converter corresponding to FIG. 7A. During the switching cycle Tsw (from t0 to t8), the diagram shows the control signals (S3 to S10) belonging to two interleaved switching phases, along with the cross-voltage waveforms (VQ1, VQ5, VQ8, VQ2) of selected switches, indicating their activation sequence and associated zero-voltage switching (ZVS) conditions.

The first switching phase includes three sequential sub-phases for switching control. In the first sub-phase (t0–t1), control signals S3 and S7 enable the switches Q3 and Q7, establishing a series electrical connection between the flying capacitors C1 and C2, while the right terminal of C3 is electrically connected to ground. In the second sub-phase (t1–t2), control signals S5 and S9 enable the switches Q5 and Q9 to electrically connect the left terminal of C3 and the right terminal of C2 to the second voltage V2. In the third sub-phase (t2–t3), the switch Q1 is turned on after VQ1 drops to zero, thereby achieving ZVS. During this three-stage process, the waveforms of VQ1 and VQ5 show their respective sequential voltage reductions to zero, enabling both the switches Q1 and Q5 to be turned on under ZVS conditions, thus reducing inrush current and improving efficiency.

The second switching phase similarly includes three sequential sub-phases for switching control. In the first sub-phase (t4–t5), signals S6 and S10 enable the switches Q6 and Q10, electrically connecting the right terminal of C3 to V2 and the right terminal of C2 to ground. In the second sub-phase (t5–t6), S4 and S8 enable Q4 and Q8 to electrically connect the right terminal of C1 to ground and the left terminal of C2 to V2. In the third sub-phase (t6–t7), Q2 is turned on, achieving ZVS. The waveforms of VQ8 and VQ2 show that the switches Q8 and Q2 are activated close to zero after experiencing gradual voltage reductions.

Overall, the waveforms in FIG. 8 further verify the feasibility and efficiency of the interleaved dual-phase architecture shown in FIG. 7A. Through multi-sub-phase sequential activation and cross-voltage control during the first switching phase and the second switching phase, at least four selected switches (Q1, Q5, Q8, Q2) are turned on under ZVS conditions. The remaining switches can be operated with zero-current switching (ZCS) as needed, comprehensively suppressing inrush current and enhancing energy conversion stability and efficiency.

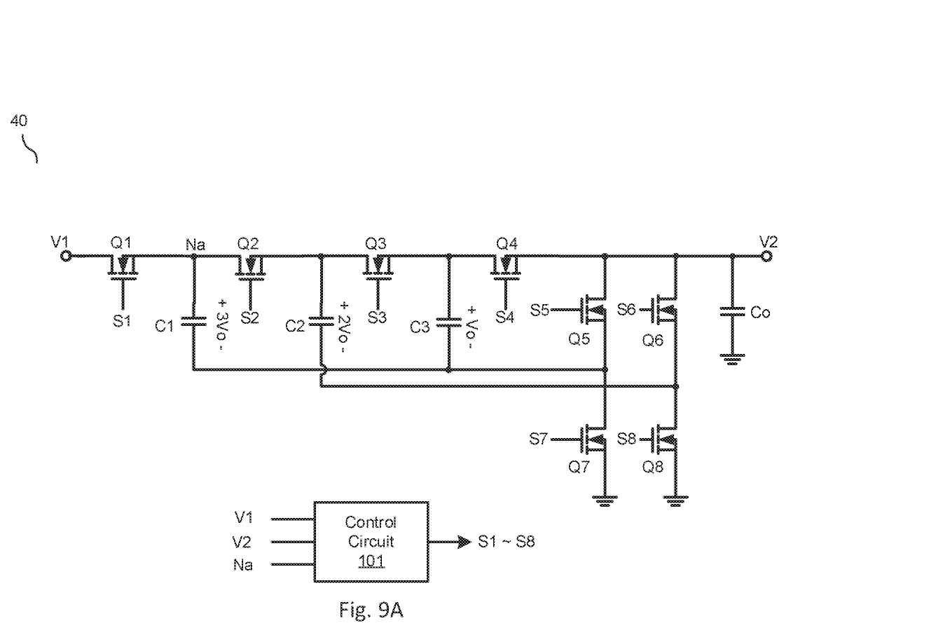

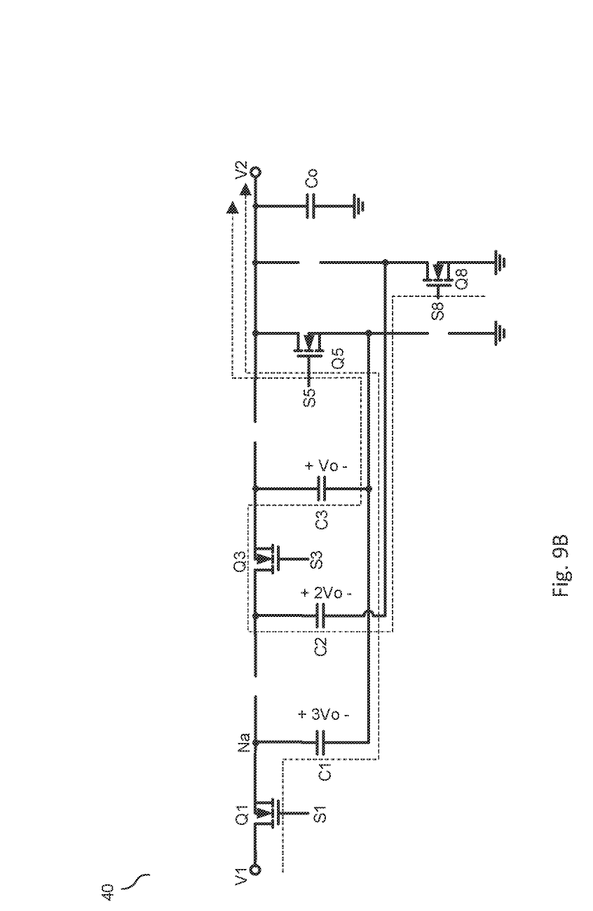

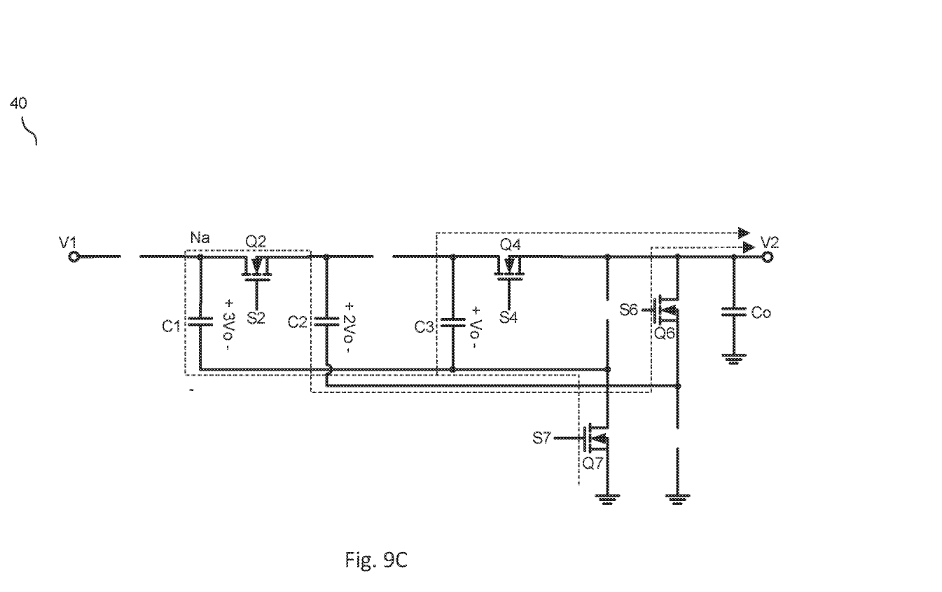

FIG. 9A illustrates a circuit schematic of a Dickson-type switched-capacitor converter according to a preferred embodiment of the present invention. In this embodiment, the switched-capacitor converter 40 comprises three flying capacitors C1, C2, and C3, and the switches Q1 to Q8. Through timing control by the control circuit, two complementary switching phases are formed to implement switched-capacitor-based power conversion. Under steady-state operation, the voltages across C1, C2, and C3 are 3×V2, 2×V2, and V2 respectively, achieving a 4:1 step-down conversion. This architecture also supports bidirectional power transfer.

FIG. 9B shows the electrical connection during the first switching phase. In this phase, the positive terminal (upper terminal) of the flying capacitor C1 is electrically connected to the first voltage V1 via the switch Q1, and its negative terminal (lower terminal) is electrically connected to the second voltage V2 via the switch Q5. Capacitors C2 and C3 are electrically connected in series between the second voltage V2 and ground. The negative terminal of C2 is electrically connected to ground via Q8, and its positive terminal is electrically connected to the positive terminal of C3, whose negative terminal is electrically connected to V2 via Q5.

FIG. 9C shows the electrical connection during the second switching phase. In this phase, the flying capacitors C1 and C2 form a series electrical connection, with their positive terminals connected together. The negative terminal of C2 is electrically connected to V2 via Q6, and the negative terminal of C1 is electrically connected to ground via Q7. The flying capacitor C3 is directly connected in parallel between V2 and ground through the switches Q4 and Q7, respectively.

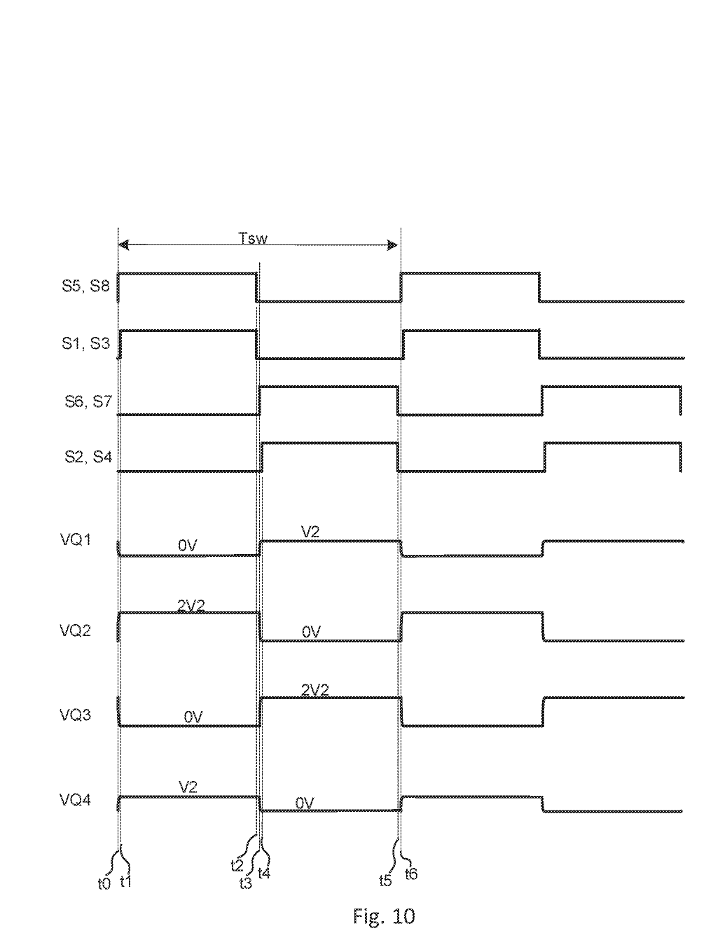

FIG. 10 illustrates the waveforms of control signals and cross-voltages of selected switches corresponding to the circuit of FIG. 9A throughout a complete switching cycle Tsw (from t0 to t6). The first switching phase (t0 to t2) includes two sub-phases. In the first sub-phase (t0–t1), control signals S5 and S8 enable Q5 and Q8 to reduce the cross-voltages of Q1 and Q3 gradually and sequentially. In the second sub-phase (t1–t2), signals S1 and S3 enable Q1 and Q3 to turn on under ZVS conditions.

The second switching phase (t3 to t5) also includes two sub-phases. In the first sub-phase (t3–t4), signals S6 and S7 enable the switches Q6 and Q7, gradually and sequentially reducing the cross-voltages of Q2 and Q4. In the second sub-phase (t4–t5), signals S2 and S4 enable Q2 and Q4, which are turned on when their cross-voltages drop near zero, thus achieving ZVS. In summary, this embodiment ensures that the switches Q1, Q2, Q3, and Q4 are all turned on under ZVS conditions by progressively reducing their cross-voltages, thereby minimizing switching losses and improving conversion efficiency.

Based on the previous figures and embodiments, the present invention proposes a systematic control strategy for effectively suppressing inrush current and reducing switching loss. This strategy applies to various switched-capacitor converter topologies comprising one or more flying capacitors, including but not limited to basic 2:1 structure, series-parallel structure, pipeline structure, and Dickson structure. In generalized designs, the conversion ratio between the first voltage V1 and the second voltage V2 may be K:1 (or 1:K), where K is an integer greater than 2 (e.g., 4:1, 5:1, 6:1, or higher-ratio multi-stage converters). Periodically switching flying capacitors in sequence in combination with the sequential control principles disclosed herein, such as activating the low-voltage terminal first, gradually enabling the high-voltage terminal, cross-voltage reduction, and timed delays, ZVS and ZCS can be broadly realized to improve overall conversion efficiency.

In converters comprising a plurality of flying capacitors, a "terminal-phase voltage difference" is defined herein as the absolute value of the voltage level difference at a given terminal of a flying capacitor across a plurality of switching phases (e.g., charging and discharging). This terminal-phase voltage difference can be used to identify the selected flying capacitors and their corresponding switches. Because a larger terminal-phase voltage difference implies a higher inrush current and loss if switched directly, ZVS control should be prioritized for such switches. If two or more flying capacitors have similar terminal-phase voltage differences, absolute voltage on terminals can be used to determine the switching sequence, ensuring gradual cross-voltage reduction from high to low, which facilitates ZVS.

In practical control sequence, a flying capacitor should first electrically connect its lower-voltage terminal to a corresponding node. This allows the cross-voltage at the higher-voltage terminal to decrease accordingly, after which the corresponding high-voltage-side switch is turned on at the appropriate time to achieve ZVS. Other flying capacitors are sequentially switched from low to high voltages according to voltage distribution, forming a gradual voltage transition that further reduces inrush current and electromagnetic interference (EMI).

When the converter topology requires a transition between different electrical connection configurations (e.g., from series to parallel) during switching phases, the present invention proposes starting from the lowest voltage node of the former series structure. Sequential and gradual voltage release ensures that the high-voltage side is switched last, completing a smooth energy transfer. In effect, this corresponds to a sequential disconnection of the series configuration, where the switching order is reversed with respect to terminal voltages. This guarantees that each switch turns on after experiencing a voltage drop, thereby enabling as many switches as possible to achieve ZVS.

In scenarios involving load current variation, the present invention also incorporates voltage drift caused by such changes into the control strategy. Although terminal voltage differences can be estimated under steady-state conditions, practical operation may introduce dynamic variations affecting switching timing. Thus, the terminal-phase voltage difference defined herein may be dynamically assessed and adjusted via real-time measurement or prediction within the controller, ensuring optimal ZVS operation even under transient conditions.

For converter topologies with a single flying capacitor, the same terminal-phase voltage difference analysis applies. The terminal with the greater terminal-phase voltage difference should be selected for ZVS control, with either a fixed delay time or a voltage-sensing circuit triggering switch activation when the cross-voltage falls below a predetermined threshold, thereby enabling efficient switching.

In conclusion, the proposed activation sequence and switching control strategy for flying capacitors not only optimize individual topologies but are also applicable to various multi-stage converter architectures. The approach offers high flexibility and scalability, allowing adaptation of the switching priority and delay settings based on different topologies and load conditions. This maximizes the number of switches that achieve ZVS or ZCS and is broadly applicable to high-efficiency, low-loss switched-capacitor power conversion systems.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A switched-capacitor converter comprising:
N flying capacitors, wherein N is equal to or greater than 1; and
a plurality of switches configured to perform periodic switching between a plurality of switching phases to convert a first voltage into a second voltage or to convert the second voltage into the first voltage;
wherein upon entering a first switching phase of the plurality of switching phases, a first terminal of one flying capacitor of the N flying capacitors is switched earlier than a second terminal thereof to electrically connect to a node corresponding to the first switching phase, thereby forming a required coupling relation for the first switching phase, such that the second terminal gradually approaches a zero-voltage state before being subsequently switched to electrically connect to a corresponding node in the first switching phase, thereby achieving zero-voltage switching.

2. The switched-capacitor converter of claim 1, wherein, under steady-state operation, a voltage of the first terminal is lower than a voltage of the second terminal.

3. The switched-capacitor converter of claim 1, wherein a terminal-phase voltage difference (ΔV_T) of the second terminal is greater than or equal to a terminal-phase voltage difference of the first terminal, wherein each terminal-phase voltage difference refers to an absolute value of a voltage level difference at the corresponding first terminal or second terminal across the plurality of switching phases.

4. The switched-capacitor converter of claim 3, wherein each terminal-phase voltage difference includes a decrease or increase in cross-voltage, due to load variation, of at least part of the N flying capacitors.

5. The switched-capacitor converter of claim 3, wherein, when N is greater than 1, in the first switching phase in which the N flying capacitors are electrically connected in series to form a voltage distribution, a selected flying capacitor having a largest terminal-phase voltage difference among the N flying capacitors is controlled such that a first terminal thereof is switched first, and subsequently a second terminal thereof is switched, so as to ensure that the second terminal of the selected flying capacitor gradually approaches a zero-voltage state, thereby achieving zero-voltage switching.

6. The switched-capacitor converter of claim 5, wherein in the first switching phase, other flying capacitors of the N flying capacitors are sequentially switched at the respective first terminals according to the voltage distribution, such that the second terminal of the selected flying capacitor gradually approaches a zero-voltage state, thereby enabling zero-voltage switching when the second terminal of the selected flying capacitor is switched to electrically connected to the corresponding node in the first switching phase.

7. The switched-capacitor converter of claim 5, wherein in the first switching phase, the second terminal of the selected flying capacitor is a last terminal, among the N flying capacitors electrically connected in series, to be switched and electrically connected to the corresponding node in the first switching phase.

8. The switched-capacitor converter of claim 5, wherein in the first switching phase, the N flying capacitors are switched sequentially such that voltages of the first and second terminals of each of the N flying capacitors increases gradually.

9. The switched-capacitor converter of claim 5, wherein when two or more flying capacitors of the N flying capacitors exhibit the largest terminal-phase voltage difference in the first switching phase, one among the two or more flying capacitors having a highest voltage potential at the corresponding first terminal is determined as the selected flying capacitor.

10. The switched-capacitor converter of claim 1, wherein the N flying capacitors are electrically connected in series to exhibit a voltage distribution in the first switching phase, and, upon switching to a second switching phase, the N flying capacitors are switched from series electrical connection to non-series electrical connection, wherein the corresponding first terminal of one of the N flying capacitors at a low-voltage end of the voltage distribution is first switched to electrically connect to a corresponding node in the second switching phase, and the respective first terminals of others of the N flying capacitors are switched sequentially according to the voltage distribution, thereby ensuring sequential disconnection of the series electrical connection and achieving zero-voltage switching at least partially.

11. The switched-capacitor converter of claim 10, wherein in the second switching phase, the N flying capacitors are switched from a series electrical connection to a parallel electrical connection.

12. The switched-capacitor converter of claim 10, wherein in the second switching phase, voltages of the first terminal and the second terminal of each of the N flying capacitors decreases gradually by sequential switching the N flying capacitors.

13. The switched-capacitor converter of claim 10, wherein a switching sequence of the N flying capacitors in the second switching phase is opposite to a switching sequence forming a series electrical connection in the first switching phase.

14. The switched-capacitor converter of claim 5, wherein the plurality of switches include:
a first switch, coupled between the first voltage and the second terminal of the one flying capacitor;
a second switch, coupled between the first terminal of the one flying capacitor and the second voltage;
a third switch, coupled between the second terminal of the one flying capacitor and the second voltage; and
a fourth switch, coupled between the first terminal of the one flying capacitor and a ground potential.

15. The switched-capacitor converter of claim 14, wherein, in the first switching phase, the second switch is turned on earlier than the first switch, such that the first switch is turned on under zero-voltage switching to charge the one flying capacitor; and in a second switching phase, the fourth switch is turned on earlier than the third switch, such that the third switch is turned on under zero-voltage switching to discharge the one flying capacitor.

16. The switched-capacitor converter of claim 14, wherein a conversion ratio between the first voltage and the second voltage is 2:1.

17. The switched-capacitor converter of claim 15, wherein the first switch is turned on after a predetermined delay time following turn-on of the second switch, and/or, the third switch is turned on after a predetermined delay time following turn-on of the fourth switch.

18. The switched-capacitor converter of claim 15, wherein the first switch is turned on when a cross-voltage of the first switch is lower than a threshold value to achieve zero-voltage switching, and/or, the third switch is turned on when a cross-voltage of the third switch is lower than a threshold value to achieve zero-voltage switching.

19. The switched-capacitor converter of claim 1, having a conversion ratio between the first voltage and the second voltage being K:1 and corresponding to a series-parallel switched-capacitor converter, where K is an integer greater than 2.

20. The switched-capacitor converter of claim 1, having a conversion ratio between the first voltage and the second voltage being K:1 and corresponding to a pipeline switched-capacitor converter or a Dickson switched-capacitor converter, where K is an integer greater than 2.

21. A method for switched-capacitor power conversion, comprising:
performing periodic switching between a plurality of switching phases to convert power between a first voltage and a second voltage; and
upon entering a first switching phase, controlling a first terminal of one flying capacitor of N flying capacitors to be electrically connected to a corresponding node earlier, such that a second terminal thereof gradually approaches a zero-voltage state before being switched, thereby achieving zero-voltage switching, wherein N is greater than or equal to 1.

22. The method of claim 21, wherein under steady-state operation, a voltage of the first terminal is lower than a voltage of the second terminal.

23. The method of claim 21, wherein the second terminal has a terminal-phase voltage difference greater than or equal to that of the first terminal, wherein the terminal-phase voltage difference refers to an absolute value of a voltage level difference at a corresponding terminal across the plurality of switching phases.

24. The method of claim 23, further comprising: when the N flying capacitors are electrically connected in series in the first switching phase of the plurality of switching phases to form a voltage distribution, controlling a selected flying capacitor having a largest terminal-phase voltage difference among the N flying capacitors, such that a first terminal thereof is switched first, and subsequently a second terminal thereof is switched, so as to ensure that the second terminal gradually approaches a zero-voltage state, thereby achieving zero-voltage switching.

25. The method of claim 24, further comprising: in the first switching phase, switching and electrically connecting the second terminal of the selected flying capacitor to the corresponding node, the second terminal being a last terminal to be switched among the N flying capacitors electrically connected in series.

26. The method of claim 24, further comprising: when two or more flying capacitors of the N flying capacitors exhibit the largest terminal-phase voltage difference in the first switching phase, determining one among the two or more flying capacitors having a highest voltage potential at the corresponding first terminal as the selected flying capacitor.

27. The method of claim 24, further comprising:
sequentially switching the N flying capacitors to a series electrical connection to exhibit a voltage distribution in the first switching phase; and
upon switching to a second switching phase of the plurality of switching phases, controlling the corresponding first terminal of one of the N flying capacitors at a lowest-voltage end of the voltage distribution to be first switched, and the respective first terminals of others of the N flying capacitors to be switched sequentially according to the voltage distribution, thereby ensuring sequential disconnection of the series electrical connection and achieving zero-voltage switching at least partially.

28. The method of claim 27, wherein a switching sequence of the N flying capacitors in the second switching phase is opposite to a switching sequence forming the series electrical connection in the first switching phase.

29. The method of claim 21, further comprising: delaying switching of the first terminal by a predetermined delay time relative to the second terminal, or delaying switching of the second terminal by a predetermined delay time relative to the first terminal, such that a voltage at the corresponding terminal decreases, thereby achieving zero-voltage switching.

30. The method of claim 21, further comprising: switching the second terminal when a cross-voltage of a corresponding switch is lower than a predetermined threshold value, thereby ensuring a corresponding switch achieves zero-voltage switching.
